(19) United States
(12) Patent Application Publication
(10) Pub. No.: US 2024/0340291 A1
(43) Pub. Date: Oct. 10, 2024

(54) TECHNIQUE FOR DETECTING CYBER ATTACKS ON RADARS

(71) Applicant: ELTA SYSTEMS LTD., Ashdod (IL)

(72) Inventor: Alexander HAZAN, Lod (IL)

(21) Appl. No.: 18/292,012

(22) PCT Filed: Jul. 17, 2022
(86) PCT No.: PCT/IL2022/050768

§ 371 Date: Jan. 25, 2024

(30) Foreign Application Priority Data
Jul. 29, 2021 (IL) 285252

(51) Int. Cl. H04L 9/40; G01S 7/40

(52) U.S. Cl. CPC H04L 63/1416; G01S 7/40; H04L 63/1425

(57) ABSTRACT

A computer-implemented technique for detecting a cyber attack in a radar system which comprises a number of modules configured to produce data reports on their performance. The modules include one or more radars and perform the following actions: monitoring operation of the radar system by collecting and processing the data reports including the radar reports, detecting one or more local anomalies at least in the radar reports, analyzing the detected local anomalies for identifying one or more correlations there-between: if the correlations are identified, determining the detected anomalies as cyber anomalies (a cyber attack). Upon detecting the cyber attack, at least one predetermined action may be taken in response.

### PRIORITY DATA

The present International patent application is filed based on the Israeli patent application No. 285252 originally filed on Jul. 29, 2021.

### TECHNOLOGICAL FIELD

The presently disclosed subject matter refers to a method and a system for detecting cyber attacks to one or more radars.

### BACKGROUND

A classical rotating air surveillance radar system detects target echoes against a background of noise. It usually reports these detections (known as “plots”) in polar coordinates representing the range and bearing of the target. In addition, noise in the radar receiver may occasionally exceed the detection threshold of the radar's false alarm rate detector and be incorrectly reported as targets (known as false alarms). The role of the radar tracker is to monitor consecutive updates from the radar system (which typically occur once every few seconds, as the antenna rotates) and to determine those sequences of plots belonging to the same target, whilst rejecting any plots believed to be false alarms. In addition, the radar tracker is able to use the sequence of plots to estimate the current speed and heading of the target. When several targets are present, the radar tracker aims to provide one track for each target, with the track history often being used to indicate where the target has come from.

A radar track typically contains information on its position (in two or three dimensions), heading, speed and a unique track number. In addition, it may include track reliability or uncertainty information.

When multiple radar systems are connected to a single reporting post, a multi-radar tracker is often used to monitor the updates from all of the radars and form tracks from the combination of detections. In this configuration, the tracks are often more accurate than those formed from single radars, as a greater number of detections can be used to estimate the tracks. In addition to associating plots, rejecting false alarms and estimating heading and speed, the radar tracker also acts as a filter, in which errors in the individual radar measurements are smoothed out. In essence, the radar tracker fits a smooth curve to the reported plots and, if done correctly, can increase the overall accuracy of the radar system.

Radar real targets acquired via RF media are usually well validated by tracking algorithms such as, for example, a Multiple Hypothesis Tracking (MHT) that classifies the targets by modeling their physical behavior and by filtering erroneous (false) tracks or clusters.

The MHT allows a track to be updated by more than one plot at each update, spawning multiple possible tracks. As each radar update is received, every possible track can be potentially updated with every new update. The MHT calculates the probability of each potential track and typically only reports the most probable of all the tracks. For reasons of finite computer memory and computational power, the MHT typically includes some approach for deleting the most unlikely potential track updates.

While radar real targets are considered, the above procedure works quite well.

Nowadays, a new problem has appeared-a possibility of cyber attacks to a radar system.

Known existing cyber protection layers are capable of preventing cyber attacks.

In case a cyber attack on a radar system is not prevented and does take place, the existing cyber protection layers demonstrate quite low efficiency in real time.

For example, such layers are inefficient against advanced persistent attacks that can be driven by software-equipped entities, such as human attackers and/or malicious computer worms such as Stuxnet etc. Such entities may target, for example, supervisory control and data acquisition (SCADA) systems of radars.

Cyber attacks are most dangerous and harmful as they may overwrite a radar system's behavior without being detected.

### GENERAL DESCRIPTION

It is therefore the object of the invention to create a cyber layer that is capable of detecting stealthy cyber attacks where an attacker gains control over a radar system.

Such a cyber attack may be understood as an attacker's control over the radar system when the system's behavior is maliciously and at least partially overwritten (changed) on a logical layer, without being immediately noted.

Malicious changes of the radar system behavior on the logical layer due to a cyber attack should be understood as causing damage to data within the radar system, which may take place without causing damage to the radar system equipment.

As a result of a cyber attack, false targets may be injected or real targets may be removed, and reported through communication channels in a radar system, in the form of false data on a specific target, for example false data on its location, plot/track, velocity, classification, etc.

Usually, only data is damaged in cyber attacks, which causes difficulties in detecting the attack.

One of the main purposes of the proposed technique is to detect a cyber attack and to identify false injected data, by monitoring the logical layer (i.e., data) in a radar system. The data to be monitored includes raw data logs of one or more radar system modules and submodules.

Inconsistent behavior in performance of radar system units (modules) may be detected based on data received from these modules.

Each inconsistency results in an anomaly which may be observed and detected in the radar reports.

Modules of a radar system, inter alia, include block/s generating electromagnetic waves (beams) to be sent to targets, blocks for collecting data received by a number of beams about each specific target, processing the collected data thus obtaining a number of plots, and forming, from the plots, a track of a specific target.

Some other modules/units of a radar system which may be affected by an attacker will be mentioned in the detailed description and illustrated in FIG. 1 (e.g., remote radar sites, external data sources, remote workstations, firewalls, SCADA, radar components, radar system network, etc.)

The new, improved radar system may comprise a data processing engine/unit for analyzing the common data input online, to determine whether the radar reports comprise false data related to a cyber attack.

Plots and tracks are the main entities to be analyzed in the proposed system. Additional entities may be specified, some of which will be discussed as the description proceeds.

All modules producing and reporting data will be monitored by a computer system of the radar system. Note that each module producing electromagnetic beams and/or other tangible physical output also issues data reports on its functioning. Such reports, among other data reports, form part of the common data input of the computer system.

It should be borne in mind that any data input in a radar system may supposedly be overwritten by an attacker during a cyber attack.

The proposed technique aims at online detection and analysis of anomalies in the radar system, for further determining whether such anomalies are cyber-oriented. The technique is implemented in and performed by a data processing engine/unit configured for detecting cyber attacks. In this description, it termed a processor and memory circuitry (PMC) or, more specifically, a Cyber Attack Detecting Unit (CADU). The unit may form part of a computer system of the radar system, but may be a stand-alone unit/product.

The technique may use Big Data infrastructure and Machine Learning algorithms to achieve its goal.

For detecting anomalies, the technique may check preliminarily selected characteristic features of specific entities, whose features may be extracted from raw input data by applying suitable algorithms. The characteristic features are extracted from raw data logs reported by various modules of the radar system, during a so-called feature extraction process. Sets of characteristic features for respective entities serve to detect whether local anomalies exist in all or any of subsystems, processes and sub-processes of the radar system. It should be kept in mind that raw data on these subsystems, processes and subprocesses is reported by various modules of the radar system.

For example, physical behavior of a track may be examined by a set of features extracted from one or more radar plots forming the track, whose set may include the following exemplary features (parameters): estimated jerk, a turn angle, type of the target, its maneuvering index, etc.

For detecting anomalies, a kind of reference should be used.

In one option, the reference may be in the form of values of the corresponding characteristic features, taking place when the radar system is not subjected to a cyber attack. Another option of the reference may be a behavioral model of the radar system built with using the characteristic features in the absence of a cyber attack.

The proposed technique may be understood as a kind of learning technique, which comprises a preliminary (training) step taking place in conventional circumstances, and applying the mentioned reference knowledge to the radar system.

Finally, a high-level algorithm (for example, a machine learning algorithm) may be applied for analysis, to identify correlations of local anomalies, to determine whether the local anomalies relate to a cyber attack. If they are such, the cyber attack is detected and actions are taken in response thereto. For example, cyber-related false tracks are detected and thus disregarded (say, eliminated from the radar display).

In this application, the term “correlations of local anomalies” may include combinations of local anomalies and/or dependencies there-between.

Further, the term “combinations” of local anomalies may include sequences thereof.

One possible correlation of local anomalies may be such that similar anomalies arrive in combinations: in groups, or in sequences/chains. For example, a number of plots/tracks detected by the radar system may be similarly biased in time; a number of plots/tracks may be similarly shifted in space; a number of plots/tracks may be presented by packets where contents of all plot points are replaced with zeros, etc.

Another kind of local anomalies may be an anomaly related to the energy conservation law. Radar produces two types of electromagnetic beams for “catching” a target: track beams and search beams. For detecting the mentioned anomaly, the proposed technique may compare the total load of a radar (in energy or in power) as reported by the radar, with the actual load of the radar. The actual (real) load may be computed by integrating the track-dwell time for a group of radars or all track and search beams during the same reported period. If there is a distinguishable mismatch between the compared values, it may be suspected that some of the tracks have been injected, removed and/or relevant data has been overwritten.

Such and other correlations of local anomalies (of the same or different kinds of the local anomalies) may be checked.

The correlations of local anomalies may be checked a) for a specific radar and/or for a group of radars; b) for radar/s and other module/s of the radar system; c) for a specific entity and/or for a group of entities, for any of a), b), c) together.

In view of the above, there is proposed a technique (a method, a system and a software product) which may be defined as follows.

A computer-implemented method for detecting a cyber attack in a radar system having a number of modules configured to produce data reports on their performance, said modules including at least one radar, the method being performed by a processor and memory circuitry unit (PMC), and comprising:
monitoring operation of the radar system by collecting and processing the data reports from said modules, including the radar reports from said at least one radar,
detecting one or more local anomalies at least in said radar reports,
analyzing the local anomalies detected in the radar reports for uncovering (identifying) one or more correlations between said local anomalies (i.e., between the local anomalies in radar reports only, or between the local anomalies in radar reports and local anomalies detected in data reports of other modules),
in case of identifying said correlations, determining the detected anomalies as cyber anomalies, thereby detecting the cyber attack,
upon detecting the cyber attack, performing at least one predetermined action to respond to it.

The PMC unit may be operatively connected and be in data communication with the radar system. It may be called a Cyber Attack Detection Unit—CADU.

Generally, the proposed method may be classified as a learning technique, where anomalies over some normal way of operation are to be detected and analyzed.

The step of analyzing the local anomalies may be performed by correlating (including finding combinations, sequences and/or dependencies of local anomalies) based at least partly on a machine learning algorithm.

The method may comprise performing said steps for one or more entities in parallel/online. Alternatively or in addition, the method may comprise performing these steps for one or more radars of the system in parallel/online.

The entire method may be performed online.

Said entities may be selected from a non-exhaustive list comprising at least a track and a plot.

The term “entity” may be illustrated by a number of examples/types. Entity types might include plots, tracks, beams, modules, entities at least partially related to energy, etc. As noted before, entities are characterized by sets of features, each of the sets reflecting (or being a function of) underlying processes.

The predetermined actions in response to the cyber attack may be, for example: issuing one or more alarms, deleting false plots or tracks created based on the radar reports, issuing urgent instructions to specific modules, etc.

### Local Anomalies Detection

In the proposed method for detecting one or more local anomalies, the raw data (at least of the radar reports) may undergo a so-called Features Extraction process, by applying relevant algorithms to the radar reports. The algorithms may be based on physical models describing the corresponding underlining radar system processes. For example, the physical models may include: a target kinematic model, an energy conservation law model, a track classification process model, etc.

A local anomaly may be detected based on checking at least one (first) set of characteristic features per entity.

More specifically, the step of detecting one or more local anomalies may comprise:
extracting from said reports a first (current) set of local characteristic features for a specific entity,
checking said first set by using a second (reference) set of respective local characteristic features, wherein said second (reference) set is relevant to a similar type of entities during normal operation of the radar system (without a cyber attack),
determining one or more local anomalies whenever said first set of the characteristic features does not correspond to said second set (i.e., differs there-from by exceeding a predetermined threshold).
   The First (Current) and the Second (Reference) Sets of Characteristic Features and how they can be Obtained

The second, reference set of local characteristic features should be understood as a set of features characterizing a specific type of entity in a situation free of a cyber attack. The reference set is usually obtained in advance.

For example, the second, reference, set of features for a rocket plot/track may comprise various physical and/or operational features: type of entity (say, plot or track), classification of the target (say a rocket, a helicopter, etc.), estimated accepted ranges/values for location, height, velocity, jerk, turn angle, maneuvering index, etc.

The reference sets of features are usually formed in advance, for example based on a radar's historic data.

The first, current set comprises a corresponding set of features which supposedly characterize said specific type of entity in a situation where a cyber attack is not excluded.

Only similar entities can be compared. In one example, a detected entity is a track. The second (reference) set of features may then refer to a generalized track, with its average expected numeric pattern, time shift, etc.

The corresponding features in the first and the second sets may differ from one another by one or more of the factors such as: presence, value, time shift, territory shift, classification, etc.

In case the extracted first, current set comprises fewer characteristic features and/or the present features respectively have values exceeding the predetermined ranges, a local anomaly may be detected.

### The Expected Behavior Models

Another way to detect one or more local anomalies (at least in said radar reports), is to utilize one or more expected behavioral models of one or more respective entity types, wherein each of said expected behavioral models is created for the radar system free of cyber attacks.

Said expected behavioral model is usually a mathematical model which may incorporate one or more of said physical models (mentioned above with reference to the feature extraction algorithms).

Since any expected behavioral model is built for a specific type of entity, it is associated with a corresponding said second (reference) set of characteristic features.

In one version, said expected behavioral model may be provided ready-made, from an outside source of information. For example, the behavioral model may be governed by a known physical law. The second, reference set of features may be then engineered/extracted from such a ready-made behavioral model. Consequently, the first set of features to be checked may be then respectively selected in accordance with the second set.

Alternatively, said at least one expected behavioral model may be built in the radar system in advance (in an offline, so-called training stage). Such a model may be built based on historical radar data collected in the absence of cyber attacks.

The obtained expected behavioral models may be stored in a database, for example in the same database of the historical radar data.

For building the expected behavioral models, the proposed method may utilize a high-level algorithm, for example a Machine Learning (ML) process using a Big Data infrastructure.

The expected behavioral models can be built for various targets (helicopters, airplanes, rockets, etc.) and for respective relevant entity types thereof (plots, tracks, etc.), so that each model is associated with its specific second (reference) set of local characteristic features. The behavioral models may be built either by utilizing such reference sets of features, or just based on historical radar data so that the reference features are extractable afterwards from the model.

It should be noted that while performing the online operations where no cyber attacks are detected, additional historical radar data may be accumulated. Also, additional behavioral models may be built online based on the updated historical radar data.

However, in case a cyber attack is indeed detected, the relevant cyber-affected radar data cannot be used for building the expected (reference) behavior models. Instead, such data may be separately accumulated so that new, cyber-affected behavioral models be built based on the cyber-affected radar data.

As mentioned above, any expected behavioral model is associated with the second (reference) set of the characteristic features. Some of the features may be physical, and some operational. Examples of the characteristic features of the second, reference set were given above (type of entity, classification of the target, estimated ranges of location, height, velocity, jerk, turn angle, maneuvering index, etc.).

Additional characteristic features, focused on possible attack vectors may be introduced into the second reference set, for example:
an expected range of GPS/space shift of the track, an expected time shift of the track, an expected type of the numeric pattern of the track, an expected range of energy spent by a radar for building a track.

Possible cyber attack vectors may be understood as directions of cyber attacks, supposedly utilized by an attacker.

For example, the cyber attack vectors may occur to be:
hiding a target, adding a target (for example, injection of false tracks), data leakage from a module of the radar system, IFF deceive (wherein IFF is Identification Friend or Foe), Denial of Service (DOS) of the radar system, sporadic changes of a target location, deletion of radar history, etc.

It should be noted that new attack vectors may be uncovered, and the proposed method and CADU may be updated/configured accordingly. In particular, more characterizing features may be developed and more behavioral models may be built in advance according to the new uncovered attack vectors, so as to detect and overcome future cyber attacks.

It should be noted that all the models built for the system (both the physical models and the behavioral models) may be periodically calibrated and updated offline, including dividing the behavioral models into two groups: expected conventional (attack-free) models and attack-related ones.

Since behavioral models relate to data, they may be calibrated from time to time (say, daily before starting a cycle), to take into account changeable data flows. For example, numerous thresholds and parameters may vary depending on daytime/nighttime, season, weather conditions, etc. The calibration procedure may be applied during the offline stage.

### Use of an Expected Behavioral Model for Local Anomaly Detection in Practice

Upon the so-called training process being carried out, e.g., when the expected behavioral models have been built during the offline stage and stored in a database, they may be fed (migrated, extracted from the database) to the online stage, thus allowing online anomaly detection.

For example, the first, current set of characteristic features can be introduced into a suitable expected behavioral model online, in order to check correspondence between the first, current set and the second, reference set of the characteristic features. If the model shows that the sets differ to an extent which is not permissible (say, one or more thresholds are exceeded), a local anomaly will be detected.

### Detection of a Cyber Incident

In addition to local anomalies, the proposed technique detects behavioral and operational anomalies by uncovering correlations (combinations, sequences and/or dependencies) of local anomalies. The behavioral anomalies may occur to be cyber-related. The mentioned behavioral and operational anomalies may be detected for example, by Machine Learning algorithms using Big Data infrastructures or by simple statistical thresholds.

The mentioned correlations (combinations, sequences and/or dependencies) of local anomalies may manifest themselves, for example, as one or more predetermined malicious anomaly sequences, as events with atypical energy consumption (especially in radars), etc. The high-level algorithm should therefore be capable of identifying various correlations of the detected local anomalies and performing analysis thereof. Analysis of the anomaly combinations/sequences may be temporal, peer group analysis, etc.

Practical examples of the predetermined operational/behavioral local anomalies coming in combinations/sequences when a radar system undergoes a cyber attack may be as follows (though other local anomalies' combinations/sequences are also possible):
Replacing data of all (or a plurality of) plot points with similar numbers, for example zeros;
Overwriting true plot/track location/identification and other properties (say, target classification, Doppler value, etc.) with properties having unusual values or changing sharply;
GPS spoofing which influences all (or a group of) tracks created in a radar system;
Common shift/bias in space or in time to all (or a group of) targets;
Identifying tracks which have been created in radar reports without utilizing a predetermined power/energy per track by corresponding radars.

At least one combination of local anomalies from the above non-exhaustive list may manifest in correlation between the local anomalies.

To this purpose, a further set of algorithms may be used, which refer to the cyber risks assessment and belong to a so-called cyber threat detection layer. This layer rectifies so-called “white-list” operational anomalies from cyber anomalies. Operational anomalies are usually single or non-correlated. For example, the anomaly that occurred in all tracks at once in the same region/time, or in a group of similar tracks/plots will be determined as a correlation, as a behavioral anomality and will manifest the presence of a cyber attack. Based on that, the affected tracks may be considered as false tracks.

Cyber anomalies may be distinguished from other operational anomalies, for example, based on one or more predefined attack vectors, some of which have been mentioned above.

One exemplary attack vector may be “injection of false tracks”, which can be detected, for example, when reported tracks appear with unstable integration/interception time on a target. That can be interpreted as wrong energy spent for target creation/detection.

Another exemplary attack vector may be “Non-physical Location Change”. If a GPS spoofing has occurred (which is a cyber anomaly), then all of radar targets will be shifted/biased; on the contrary, a shift/jump in a single track may be caused by a track filter misfunctioning operational anomaly, and does not comply with possible cyber attacks.

Further, there will be provided a processor and memory circuitry (PMC) configured to function as a data processing engine/unit for detecting cyber attacks (CADU), a computer system comprising the PMC (CADU), a radar system comprising PMC (CADU), and a suitable software product.

A processor and memory circuitry (PMC) is designed for detecting a cyber attack in a radar system having a number of modules configured to produce data reports on their performance, said number of modules including at least one radar; said PMC being configured as operatively connectable to and capable of establishing data communication with said modules for performing the following steps, preferably and mainly online:
monitoring operation of the radar system by collecting and processing the data reports from said modules, including the radar reports from said at least one radar,
detecting one or more local anomalies at least in said radar reports (for example, by a feature extraction unit and an anomaly detection unit, using reference sets of characteristic features and/or expected behavioral models from a radar database),
analyzing the local anomalies detected in the radar reports for identifying one or more correlations between said local anomalies (for example, between the local anomalies detected in the radar reports only or between those detected in the radar report/s, and other modules of the system, for example, by correlating and analyzing the detected local anomalies in a Cyber discriminator unit)
in case of identifying said correlations, determining the detected anomalies as cyber anomalies, thus detecting the cyber attack (for example, by detecting combinations or sequences of anomalies by said Cyber discriminator unit),
upon detecting the cyber attack, performing at least one predetermined action to respond thereto (for example, issuing an alarm by the Cyber discriminator unit).
   More specifically,
the feature extraction unit may be configured for extracting a set of current characteristic features per entity,
the anomaly detection unit may be configured for detecting local anomalies per entity, based on the extracted set of current characteristic features and using a reference set of characteristic features or an expected behavioral model,
the unit for analyzing local anomalies may be configured for correlating the detected local anomalies;
the Cyber discriminator unit may be configured for analysis of correlations if such are revealed, and for issuing a predetermined action in case of detecting correlations (for example, some malicious sequences) of the local anomalies.

The correlations may be predetermined, when the attack vectors and attack-related behavior models are already known. However, it is never known in advance, whether an attacker has invented a new attack vector, so new correlation/s may be detected which may serve for determining new attacks and even a new type/vector of cyber attacks.

All versions of the method, which have been described with reference to the method, apply mutatis mutandis to the above-defined data processing PMC (CADU) unit and present its various embodiments.

The PM (CADU) may incorporate a database for storing at least attack-free historical radar data (and optionally, also attack-related historical data) for creating therefrom the mentioned references suitable for detection of cyber attacks.

The historical radar data may be divided into attack-free data and attack-related data. Accordingly, the historical radar attack-free data may comprise sets of reference features and reference behavioral models. Similarly, the historical radar attack-related data may comprise sets of attack-related features and attack-related behavioral models.

The PMC (CADU) may be implemented as a stand-alone unit, for example, a processor, a computer, a disk-on-key, or a separate server.

There are also provided a control system comprising the defined PMC (CADU) unit, and a radar system comprising said PMC (CADU) unit.

According to yet another aspect of the invention, there is provided a software product comprising computer-implementable instructions and data stored on a non-transitory computer readable storage medium and designed to cause a processor and memory circuitry PMC (for example, CADU) of a radar system to take steps of the method defined above, namely:
monitoring operation of the radar system by collecting and processing data reports from modules of the system, including radar reports from at least one radar,
detecting one or more local anomalies at least in said radar reports,
analyzing the local anomalies detected in the data reports for identifying one or more predetermined correlations between the detected local anomalies (detected in the radar reports only or taking into account also data reports of other modules of the system),
in case of identifying said correlations, determining the detected anomalies as cyber anomalies, thus detecting the cyber attack,
upon detecting the cyber attack, performing at least one predetermined action to respond thereto.

The versions of the method, described above, apply mutatis mutandis to the software product defined above.

There is also provided at least one non-transitory computer readable storage medium having said software product stored thereon.

### BRIEF DESCRIPTION OF THE DRAWINGS

The proposed subject matter will be further described and illustrated by the following non-limiting drawing, in which:

FIG. 1 is a block-diagram which schematically illustrates main components of a radar system, which may potentially be affected by an attacker. The radar system is provided with a newly proposed processor and memory circuitry PMC, marked as a Cyber Attack Detecting Unit (CADU) which monitors the data flow produced by components of the radar system.

FIG. 2 is a block diagram schematically illustrating one version of the proposed method and one embodiment of the proposed system for detecting cyber attacks in a radar system.

FIG. 3 is a block diagram schematically illustrating exemplary offline steps of the proposed method, as well as an exemplary high-level architecture of the proposed unit (for example, CADU) for constructing, offline, one or more expected behavioral models of the radar system, for further use in detecting cyber attacks.

FIG. 4 is a block diagram schematically illustrating exemplary online steps of the proposed method, as well as an exemplary high level online architecture for monitoring at least radar data reports representing one or more entities to be analyzed. The technique comprises extracting, from that data, characteristic features of the entities. These features may optionally be used for building/updating a radar database of extracted features (first sets of characteristic features). The online technique is intended for detecting anomalies in a radar system based on the extracted features and using the expected behavioral models or reference sets of conventional features (second sets of features), and for further analyzing whether the detected anomalies are cyber anomalies.

FIG. 5 is a simplified exemplary flow chart of the proposed method for detecting a cyber attack in a radar system.

### DETAILED DESCRIPTION OF SPECIFIC EMBODIMENTS

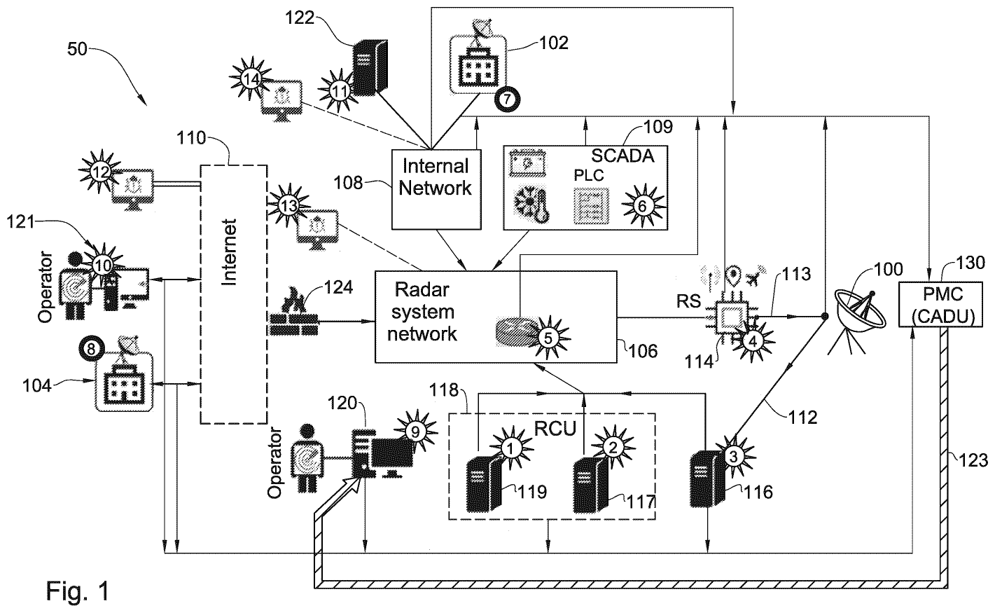

FIG. 1 presents an exemplary network configuration of a radar system 50, which can be used in both civil and military setups. The radar system network 106 is usually based on the Ethernet protocol as data link layer protocol and TCP/IP protocols as network and transport layers. The following main components of the system are presented in FIG. 1.

Antenna (Radar) 100 performs transformation of the electric current into electromagnetic waves and vice versa (transmission and reception respectively). Usually, one bidirectional antenna is used, however, radar systems with two separate antennas (one transmitter and one receiver) also exist (a bi-static radar).

The main radar system network 106 can be connected to an organizational internal Network 108, to a SCADA network 109 that controls the utility services of the radar system (power, air conditioning, etc.), and to external entities over the Internet (110). The asterisk-like marks numbered (1, 2, 3, 4, 5, 6, 10, 11, 12, 13, 14) indicate a potential location of an attacker. More specifically:
(1,2,3,4,5,9)—attacker is located and controls one of the radar components on the local radar system network;
(6)—attacker is located in the SCADA system that controls utility services of the radar system;
(12,13,14)—attacker connects his own device to the system/networks;
   The bold-ring marks numbered 7 and 8 indicate locations where an attacker could damage information that is required by the system. In this example, the attacker may be located in a remote radar system 102, 104 and may be gaining connection to the radar network.
Signal processing unit (SP) 116. Receives the signals from the antenna 100 (usually via an optical link 112) and analyzes the signal using a signal processing algorithm aiming at identifying potentially relevant objects. The output, which is referred to as plots (describing the location of the found objects) is sent to the tracking algorithm server 118 (usually via the radar system Ethernet network 106).
Radar Sync (RS) 114. This is a main real time, embedded hardware unit. RS 114 receives data via optical link 113 and controls the antenna's 100 modes of operation; for example, controls rotation speed, start/stop, transmission frequency (Tx) configuration, and receiving signal processing (Rx) such as signal amplification and noise filtering.
Controller 117. The mediator of the system. Among other tasks, it is responsible for distributing configuration setup to the radar system components during start-up.
Tracking unit 119. Analyzes the received plots and applies an algorithm on the plots to identify objects, classify the type of objects, and track object movement.
Operator workstation 120. The system's operator workstation. This is the component that is used by the operator in order to examine the status of the system (e.g., services that are currently running, areas scanned by the antenna, etc.), manage system components, and explore objects discovered by the system. As seen in FIG. 1, more operator workstations (say, 121) may be located at remote locations.
External data sources 122. Some inputs to the radar system may include external data sources such as ADS-B (automatic dependent surveillance broadcasting) communications, as well as databases that include intelligence on the monitored objects (for example, for inferring the type of detected objects and determining whether it is a “friend-or-foe”).
Remote radar site 104, 102. The radar system can communicate for information sharing with other remote radar sites.
SCADA System 109. Supervisory control and data acquisition (SCADA) system is a computing system that monitors and controls facilities from a centralized location. The main elements of a SCADA system are sensors (collect information from the environment), actuators (trigger changes in the physical environment), human-machine interface (the component used by the administrator to manage the system), and programmable logic controllers (used to manage the system). All of these components are interconnected and communicate with each other. A typical SCADA system manages various utility systems, for example air-conditioning, electricity and radar motor systems. SCADA may also be affected by an attacker.

In FIG. 1, the radar system 50 is provided with the proposed processor and memory circuitry PMC shown as a data processing Cyber Attack Detecting Unit CADU 130, which may be a stand-alone unit operatively connected to the radar system 50 via a hardware-based I/O interface (not shown), to establish data communication with the system 50. CADU collects and processes online data reports from a plurality of the radar system components, including radar data reports from modules 100,102, 104 (see a plurality of arrows shown in the drawing, which indicate online data reports). As a result of the online processing, the CADU 130 may detect a Cyber Incident and issue an alarm/indication 123, for example to the workstation 120, so that the Operator may take suitable measures (say, to eliminate false rocket tracks and/or the like).

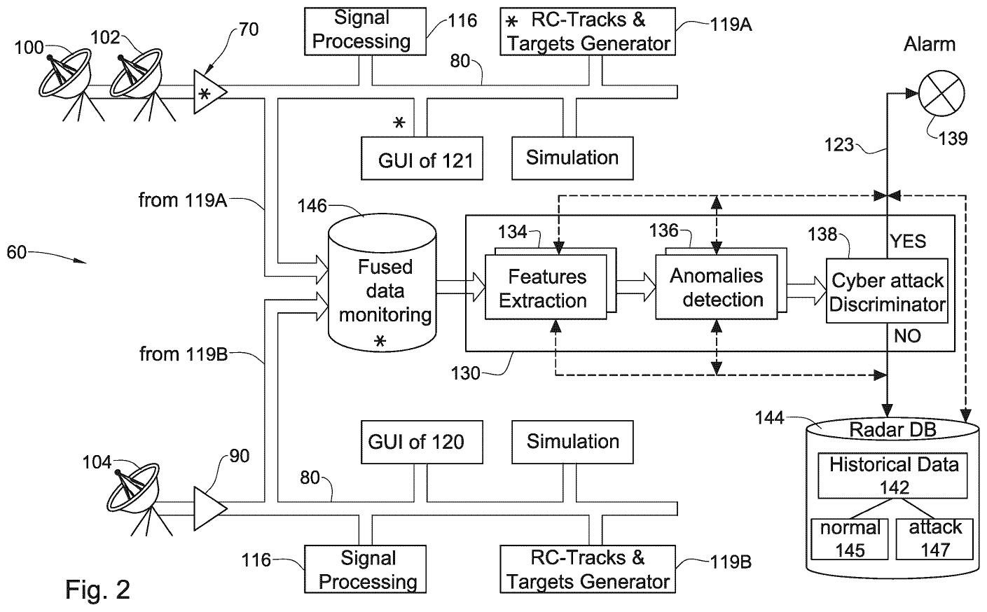

FIG. 2 shows a simplified block diagram which illustrates a slightly different embodiment of the radar system 60 provided with the proposed PMC (CADU) 130, with schematic functional connections between modules of the system and blocks of the CADU unit.

Data reports of radars 100 and 102 are marked as 70, incoming data bus 80 of the radar system 60. Assume that data reports 70 of the radars 100, 102 are damaged by an attacker (marked by a black asterisk). As a result, the Generator of the Tracks and Targets of the Unit schematically marked 119A (see 119 in FIG. 1) will produce false entities (tracks) based on the reports 70; the operation of GUI 121 will also be affected. The false data/entities are schematically marked with black asterisks in the blocks 119A and 121.

The false or damaged information on the tracks will be fused to a data block 146, for monitoring the input data of the radar system. This is also marked by the black asterisk in the block 146.

Assume that the Radar 104 (see FIG. 1) is not affected by a cyber attack and its data report 90 is clean. The Tracker block schematically marked 119B (to formally distinguish it from 119A) creates true plots and tracks based on the radar report 90. The information from 119B is fed and then injected into the data monitoring block 146, where it will be mixed with the damaged data from 119A. The data monitoring 146 feeds all the collected data into the PMC 130 in the form of a Cyber Attack Detection Unit (CADU).

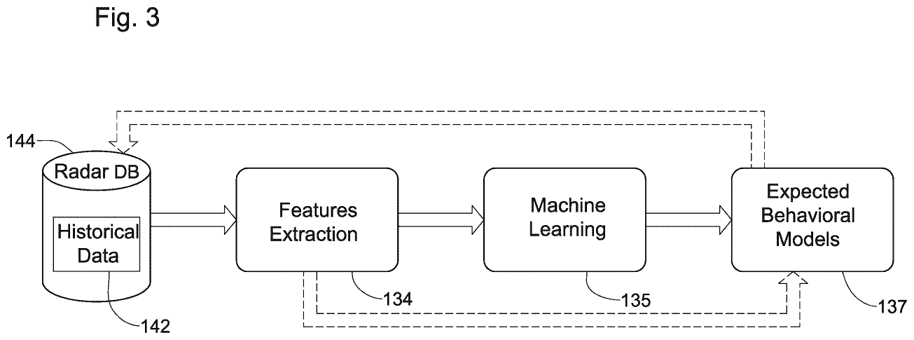

As in FIG. 1, the radar system includes a processor and memory circuitry (PMC) 130. It is operatively connected to the system via a hardware-based I/O interface (not shown separately). PMC 130 is configured to provide data processing necessary for operating the system as further detailed with reference to FIGS. 3, 4 and 5, and comprises a processor (not shown separately) and a memory (not shown separately). The processor of PMC 130 can be configured to execute several functional modules in accordance with computer-readable instructions implemented on a non-transitory computer-readable memory comprised in the PMC. Such functional modules, whenever referred to hereinafter, should be understood as comprised in the PMC.

The functional modules comprised in PMC 130 (CADU) can include a features extraction module 134, a local anomalies detection module 136 and a cyber attack discriminating module 138.

In the CADU, each entity in the arriving data flow will be subjected to extraction of current features of the entity, by the corresponding block 134. The features extraction may be performed in different ways: based on a reference set of features, using one or more physical models relevant to the entity, or using a behavior model. The set of features or a model may be received either from an outside source (not shown), or from a radar database 144, more specifically from historical data 142 stored in it. The database 144 (at least its updatable historical data folder 142) may form an integral part of the CADU 130.

Communication between modules 134, 136 and 144 is indicated by bidirectional dash lines.

It should be noted that when there is no cyber attack (for example, that fact is confirmed by CADU 130 as “NO”), the feature extraction unit 134 may update the historical radar data 142 (folder 145, see below) with the currently extracted features, with respect to that specific type of entity.

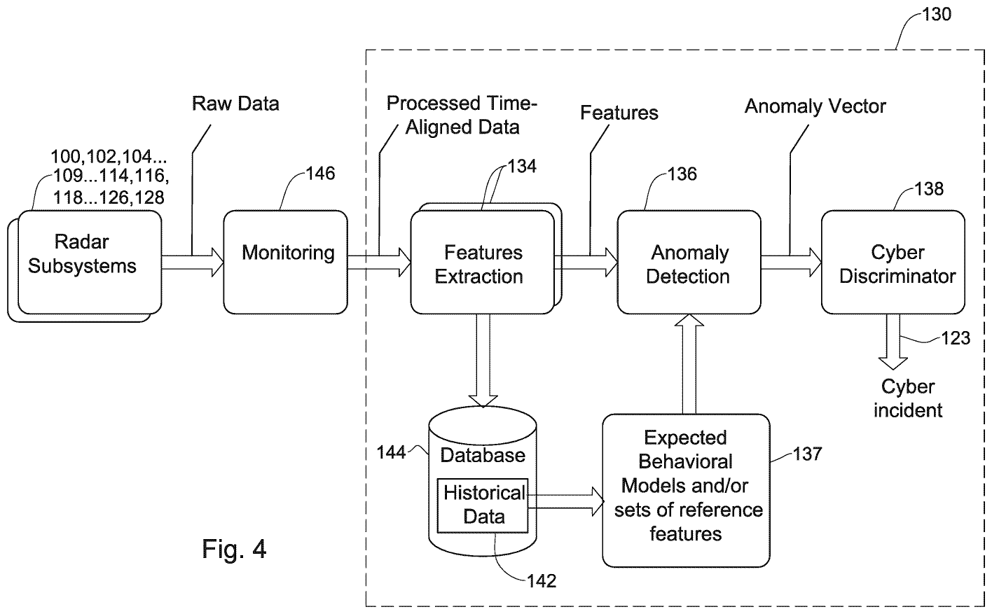

The extracted current set of features is then subjected to local anomalies detection in block 136. Local anomalies (in this case, for radars 100 and 102 and their subsystems) may be detected, for example, by comparing the extracted current set of features with a reference set of features, or by introducing the current set of features to an expected behavior model suitable for the specific entity. The suitable set of features, or the suitable expected behavioral model, may be received either from an outside source (not shown), or from the radar database 144, more specifically from historical data 142 (folder 145) stored in it. Communication between modules 136 and 144 is indicated with dash lines. (See also FIG. 4.)

It should be kept in mind, that a number of entities (tracks, etc.) may be processed simultaneously in the units 134, 136, therefore a number of local anomalies may be obtained.

Also, in addition to radar reports, other data reports may be processed by CADU, which are not shown in this diagram, but shown for example in FIG. 1.

Upon detecting local anomalies in unit 136, unit 138 of the CADU checks whether there are correlations and/or dependencies between the local anomalies in radar reports, and probably between them and other anomalies detected by the unit 136. High level algorithms may be applied for this purpose.

If such correlations are detected, they are further checked to discriminate between operational anomalies and cyber-related ones. In case cyber-related anomalies are detected, block 138 issues a predetermined action, for example an alarm 139 and an instruction to the database 144, whether to update its Historical Data 142, and how to do so.

It should be noted that the historical data 142 of the database 144 may be divided into two folders: attack-free data 145 which has been discussed, and attack-related data 147. The folder of historical attack-related data 147 might be created offline and be updated each time when CADU 130 detects a cyber attack. More specifically, attack reference features and/or attack behavior models may be created, stored in the folder 147, and used for providing an attack reference to the blocks 134 or 136 (for example, to allow the express attack detection).

FIG. 3 schematically shows an option of how (and by which functional blocks) the discussed expected behavioral models of a radar system can be created. FIG. 3 shows an exemplary learning, offline stage of the proposed method.

Database 144 stores an historical radar data folder 142 concerning operation of the radar system in the absence of cyber attacks. For example, data on a huge number of typical entities (say, rocket tracks) may exist in the data folder 142. Data on some of the entities may be selected from the historical radar data and be used by feature extraction process in the block 134. The characteristic features of such entities may be extracted, for example, by using physical models (a kinematic model, etc.). Sets of characteristic features extracted for such typical entities may be considered so-called reference sets. Then, by applying a high-level Machine Learning algorithm (within block 135) to the extracted features, one or more expected behavioral models 137 can be built. These models 137 (actually being reference models) may then form a subfolder of attack-free behavioral models and may be stored in folder 145 of the historical radar data 142.

Optionally, the reference sets of features extracted by module 134, may also be stored in the folder 137 (and then together in the historical data 142).

FIG. 4 schematically presents exemplary online steps of the proposed method, as well as an exemplary high level online architecture for monitoring at least radar data reports of the radar systems. The radar and other data reports form raw data and represent one or more entities to be monitored and analyzed (in this example the entities will be plots and/or tracks). The figure shows radar subsystems (see for example various modules shown in FIG. 1) producing raw data, a data monitoring block 146 which collects, processes and forwards the processed time-aligned data on the entities to the CADU (PMC) unit 130. The unit 130 comprises the feature extraction unit 134, now operating online. The block 134 extracts from the processed data one or more sets of current characteristic features of one or more respective entities (per entity). These current sets of features are sent for analysis to the Anomaly detection unit 136, but may also be stored in the Radar Database 144. Later, these sets may become part of Historical data 142, upon being stored to the suitable folder 145 or 147. It should be noted however, that attack-related sets/models from folder 147 are never used for calibration. In unit 136, the sets of current characteristic features are used for detecting local anomalies in a radar system. For reference, unit 136 receives reference data from unit (folder) 137. The reference data may be some expected behavioral models (received either from outside, or obtained from the database 142, see FIG. 3). Alternatively or in addition, the reference data 137 may comprise sets of reference features of relevant entities (being free of cyber attacks), which may be used for comparison in unit 136, instead of the behavioral models. Assume a number of local anomalies is detected in one or more processed entities. The plurality of local anomalies (which form a kind of anomalies vector but are not yet analyzed) are sent to the cyber discriminator unit 138.

The analysis whether the detected local anomalies are cyber anomalies requires some additional processing. Namely, the unit 138 (cyber discriminator) applies high level algorithms for checking whether there are correlations in the-detected plurality of local anomalies (say, in the form combinations, sequences and/or dependencies of the local anomalies). If such correlations are detected, a cyber incident may be determined. The correlations may correspond to some “predetermined” attack vectors known in advance for typical attacks. However, new correlations may be revealed, and new types/vectors of cyber attacks may be detected (and may accordingly be stored in the database 144 in the attack folder 147).

One exemplary attack vector, i.e., the injection of false tracks, will be described below. Any attack vector may be characterized by a combination of anomalies.

It should be noted that entities other than tracks and plots may be analyzed in the system.

There may, for example, be an entity at least partially related to the energy conservation law. Such an entity may be a hybrid entity which will be explained below. Radars comprise modules a) for forming, tracking and searching (scanning) electromagnetic beams, b) for registering information associated with such beams both before and after meeting of the beams with a specific target, and c) for processing the information obtained upon the beams' meeting with the target. Usually, radar reports comprise data on energy spent by the radar modules for creating a real track of a real target.

An attacker may create false tracks which are formed without spending energy of the radar.

Radar reports may therefore not correspond to the real energy spent by the radar system. To detect such a cyber attack, a hybrid entity may be constructed, which comprises (in the set of characteristic features) both the feature(s) related to data in a number of radar track reports, and the feature(s) related to the energy consumption of the radar. Alternatively, a regular entity (say, a track) may be analyzed with reference to some separately received data on energy consumption of the radar. Such a set of separately received data may be understood as a contradictive and therefore can be interpreted as caused by a cyber attack. As a result, a correlation (combination, dependence, sequence, etc.) of local anomalies may be detected.

In other words, in this specific case an anomaly in energy spent or not spent by radars for building tracks may be an indication of the mentioned specific attack vector (“injection of false tracks”).

Inter alia, FIG. 4 also illustrates that the CADU unit 130 for detecting cyber attacks may include a database (144) with updatable historic data 142 on radars. The updates may be provided not only from the block 134 of features extraction, but also from the cyber discriminator 138.

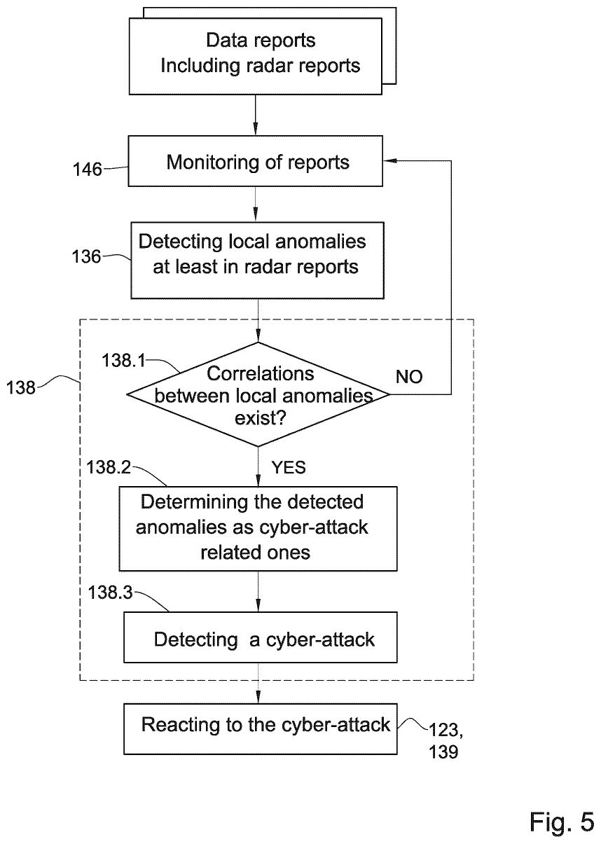

FIG. 5 is a simplified exemplary flow chart of the proposed method, where blocks of the flow chart are schematically marked with reference numerals of the system units and data flows mentioned in the previous figures. Step 138 (cyber attack discrimination) comprises a sub-step 138.1 for detecting correlations between local anomalies and reporting them, a sub-step 138.2 for determining whether the detected anomalies are cyber-related, and a sub-step 138.3 for detecting a cyber attack.

Having described the invention with regard to certain specific embodiments thereof, it is to be understood that the description is not meant as a limitation, as further versions of the method, modifications of the PMC and the radar system will now become apparent to those skilled in the art, so that the description and the claims which follow are intended to cover such versions and modifications.

1-27. (canceled)

28. A computer-implemented method for detecting a cyber attack in a radar system, the radar system comprising a number of modules configured to produce data reports on their performance, the number of modules including at least one radar,
the method performed by a processor and memory circuitry (PMC) and comprising:
monitoring operation of the radar system by collecting and processing the data reports from said modules, including the radar reports from said at least one radar,
detecting one or more local anomalies at least in said radar reports,
analyzing the detected local anomalies for identifying one or more correlations between said local anomalies,
in case of identifying said correlations, determining the detected anomalies as cyber anomalies, thereby detecting the cyber attack,
upon detecting the cyber attack, performing at least one predetermined action to respond thereto.

29. The method according to claim 28, performed for one or more entities online, wherein said one or more entities are selected from a non-exhaustive list comprising a track, a plot, an entity at least partially related to energy consumption.

30. The method according to claim 28, wherein said one or more correlations include one or more combinations, sequences and/or dependencies of the local anomalies.

31. The method according to claim 28, wherein the step of analyzing the local anomalies comprises correlating based at least partly on a Machine Learning (ML) algorithm.

32. The method according claim 29, wherein at the step of detecting one or more local anomalies, a local anomality is detected based on checking at least one current set of characteristic features per entity, said step comprising:
extracting from said reports a first, current set of local characteristic features for a specific entity,
checking said first, current set by using a second, reference set of respective local characteristic features, wherein said reference set is relevant to a similar type of entities during normal operation of the radar system,
determining one or more local anomalies whenever said first set of the characteristic features does not correspond to said second set.

33. The method according to claim 32, wherein the reference set of characteristic features for an entity comprises one or more features from the following non-exhaustive list: type of entity, classification of a target, estimated accepted ranges and/or value of location, height, velocity, jerk, turn angle, maneuvering index.

34. The method according to claim 28, wherein the step of detecting one or more local anomalies in radar reports comprises applying one or more expected behavioral models created for the radar system free of cyber attacks.

35. The method according to claim 32, wherein the step of checking said first, current set of characteristic features is performed by applying an expected behavioral model of the similar type of entities, wherein said expected behavioral model is created for the radar system free of cyber attacks and is associated with said second, reference set of characteristic features.

36. The method according to claim 34, wherein said at least one expected behavioral model is built in the radar system based on historical radar data collected in the absence of cyber attacks.

37. The method according to claim 32, wherein said expected behavioral models are built by applying a Machine Learning (ML) algorithm using a Big Data infrastructure.

38. The method according to claim 33, wherein the entity is a track, and wherein the second reference set of characteristic features comprises one or more additional features from the following non-exhaustive list:
an expected range of GPS/space shift of a track, an expected time shift of a track, an expected type of the numeric pattern of a track, an expected range of energy spent by a radar per building a track.

39. The method according to claim 28, further comprising analyzing said correlations with reference to preliminarily known cyber attack vectors for detecting the cyber attack.

40. The method according to claim 28, wherein identifying said correlations of the local anomalies comprises detecting one or more combinations of the local anomalies and wherein the one or more anomaly combinations are selected from the following non-exhaustive list:
Replacing data of all or a plurality of plot points with similar numbers
A GPS spoofing-influenced group of tracks created in a radar system
A common bias in space or in time to a group of tracks
Atypical energy consumption for tracks created in the radar system.

41. The method according claim 28, additionally comprising a step of collecting attack-related historical data for use in express detection of cyber attacks, and
initialization, based on the attack-related historical data, one or more attack-related behavioral models and/or attack-related reference sets of features, for performing express detection of a cyber attack.

42. A processor and memory circuitry (PMC) designed for detecting a cyber attack in a radar system having a number of modules configured to produce data reports on their performance, said modules including at least one radar; said PMC being configured to be operatively connected to and to establish data communication with said modules for performing the following steps:
monitoring operation of the radar system by collecting and processing the data reports from said modules, including the radar reports from said at least one radar,
detecting one or more local anomalies at least in said radar reports,
analyzing the local anomalies detected for identifying one or more correlations between said local anomalies,
in case of identifying said correlations, determining the detected anomalies as cyber anomalies, thus detecting the cyber attack,
upon detecting the cyber attack, performing at least one predetermined action to respond thereto.

43. The PMC according to claim 42 comprising:
a feature extraction unit for extracting a set of current characteristic features per entity,
an anomaly detection unit, for detecting local anomalies per entity, based on the extracted set of current characteristic features and using a reference set of characteristic features or an expected behavioral model,
a unit for analyzing local anomalies by correlating the detected local anomalies so as to reveal at least one correlation in the form of a combination, sequence and/or dependency of the local anomalies,
a cyber discriminator unit for analysis of said correlation if revealed, and for issuing a predetermined action in case of detecting said correlation of the local anomalies.

44. The PMC according to claim 42, comprising a database storing at least attack-free historical data for creating references in detection of cyber attacks.

45. The PMC according to claim 44, wherein the database storing also attack-related historical data for creating references in express detection of cyber attacks.

46. A radar system comprising the PMC according to claim 42.

47. A non-transitory computer readable storage medium comprising computer-implementable instructions and data for causing a processor and memory circuitry (PMC) of a radar system to perform the method steps including:
monitoring operation of the radar system by collecting and processing data reports from modules of the system, including radar reports from at least one radar,
detecting one or more local anomalies at least in said radar reports,
analyzing the local anomalies detected for identifying one or more correlations between said local anomalies,
in case of identifying said correlations, determining the detected anomalies as cyber anomalies, thus detecting the cyber attack,
upon detecting the cyber attack, performing at least one predetermined action to respond thereto.
